(19) United States
(12) Patent Application Publication
(10) Pub. No.: US 2025/0171620 A1
(43) Pub. Date: May 29, 2025

(54) CLEAR BINDER COMPOSITION, AND USES THEREOF FOR ROAD SURFACING AND DEVELOPMENT SURFACING

(71) Applicant: VINCI CONSTRUCTION, NANTERRE (FR)

(72) Inventors: Thomas LEBARBE, AUDENGE (FR); Juliette PARISOT, BORDEAUX (FR); Marie-Laure PIERRE, VILLENAVE D'ORNON (FR)

(73) Assignee: VINCI CONSTRUCTION, NANTERRE (FR)

(21) Appl. No.: 18/729,451

(22) PCT Filed: Jan. 17, 2023
(86) PCT No.: PCT/FR2023/050059

§ 371 Date: Jul. 16, 2024

(30) Foreign Application Priority Data
Jan. 17, 2022 (FR) FR2200365

(51) Int. Cl. C08K 11/00; C08L 23/0869; C08L 23/20

(52) U.S. Cl. CPC C08K 11/00; C08L 23/0869; C08L 23/20; C08L 2205/02; C08L 2207/32

(57) ABSTRACT

The present invention relates to the field of transport infrastructures and urban planning and development infrastructures, in particular clear or coloured surfacing containing clear binders. More particularly, the present invention relates to a clear binder composition comprising one or more ethylene and alkyl acrylate copolymers having a melt flow rate greater than 2.5 g/10 min and a melting temperature greater than 85° C.

### FIELD OF THE INVENTION

The present invention relates to the field of transport infrastructures and urban development infrastructures, in particular clear or coloured surfacings containing clear binders. More particularly, the present invention relates to a clear binder composition comprising one or more ethylene and alkyl acrylate copolymers having a melt flow index greater than 2.5 g/10 min and a melting temperature greater than 85° C. The use of such copolymers enables the application of surfacings at lower temperature while giving it good resistance to permanent deformation at the temperatures of use.

### TECHNICAL BACKGROUND

Conventional bituminous binders, used in road construction, are black and are therefore difficult to colour. This inability to colour bituminous binders is explained by the black colour of asphaltenes, which compounds are intrinsically present in bitumens.

Surfacing made from clear binders enables the production of mixes, the shade of which is that of the granular materials which constitute them or optionally that of a shade that is coloured by the addition of pigments. The users of urban roads (pedestrians, cyclists, car drivers) are particularly sensitive to the shade of the surfacings on which they are travelling. The colour provides an appearance that is essential to the harmonious integration of roadways in their environment, but also facilitates their readability. In addition to the aesthetic advantages provided by clear binders, these products are also appreciated for certain particular uses: as surfacings for roadways of tunnels and underground passages, they lead to economies in lighting and improve visibility and therefore safety; as a running surface layer for a road structure, they enable a reduction in the temperature reached by the surfacing exposed to the sun and thus limit the thermal stresses on the apron of the structure; finally, in urban environments, they enable the surface temperature of the coating to be limited and thus contribute to the fight against urban heat islands.

Clear or coloured surfacings based on the use of synthetic coating binders have the same properties as conventional bitumens, but without the black colour. These synthetic binders, produced from components of petroleum origin, do not include asphaltenes and thus have a clear, translucent or transparent appearance in a thin film. The clear binders of the prior art are generally formed of a mixture of petroleum oils, hydrocarbon petroleum resins and polymers.

However, the clear binders known to a person skilled in the art must be heated to temperatures between 150° C. and 200° C. in order to mix them with solid mineral particles that are also heated to this same temperature range. Production at these temperatures enables good fluidity of the composition and a workability suitable for mechanised or manual application on a work site. However, the surfacing applied on a work site is generally at a temperature greater than 140-150° C., thus generating significant smoke emissions. If the production temperature, and therefore the application temperature, of these clear surfacings is lowered, significant problems of workability are observed. More specifically, the use of poly(styrene-b-butadiene-b-styrene) (SBS) or styrene-ethylene-butylene-styrene (SEBS) elastomers and the binders of the prior art leads to a filamentous nature of the binders when the temperature drops below 120-130° C. and when the surfacing is manipulated. This filamentous nature makes the application of clear binders impossible at lower temperature, considering the rapid reduction in temperature of the surfacing during application on a work site. The filamentous nature means that the binder becomes more viscous and forms threads between the solid mineral particles when the composition is manipulated. This filamentous state makes manual application impossible and can compromise the durability of the surfacing in the sense that the cohesion of the surfacing can be disrupted due to unsatisfactory compacting or laying of the surfacing. A method for reducing the filamentous nature of surfacings containing clear synthetic binders consists of reducing the content of elastomer in the composition of the binder. However, this method strongly impacts the resistance to permanent deformation. The surfacings resulting from this method are therefore no longer suitable for use within a wide window of traffic and temperature.

Patent application EP1481023 describes a clear binder composition which comprises 0.05 to 3% by mass of an amide additive which enables the workability temperature of the clear surfacing to be reduced. However, this patent application mentions the use of polymers such as SBS or styrene-isoprene-styrene (SIS) elastomers. The filamentous nature at a temperature less than 120-130° C. is therefore not removed, despite the reduction in dynamic viscosity of the binder.

Patent application WO 2017/076814 describes a synthetic binder composition for producing clear surfacings, which comprises a solvent-extracted petroleum oil, a petroleum resin, a SEBS elastomer having a styrene content of 25-35% and an ethylene and ethyl acrylate (EEA) copolymer having an ethyl acrylate (EA) content of 10-25% and a melt flow index (MFR or MFI) of 0.5 g/10 min at 2.5 g/10 min. This patent application specifies that the content of SEBS, denoted y (% by mass), is characterised by −0.6x+3.1≤y≤−0.5x+6.1 and 0≤y≤2.8, where x is the content (% by mass) of EEA copolymer. The ethylene and ethyl acrylate copolymers described in application WO 2017/076814 have a melt flow index between 0.5 and 2.5 g/10 min. The use of polymers having such a low melt flow index, does not make it possible to obtain dynamic viscosity values at 150 or 180° C. which are sufficiently low to enable an application of clear surfacings at low temperature (temperature less than 140-150° C.).

There is therefore a need to provide clear binder compositions, the workability of which, characterised by the dynamic viscosity of the binder and the absence de filamentous nature, is suitable for a low-temperature application while ensuring good resistance to traffic of the surfacings prepared from such compositions.

### BRIEF DESCRIPTION OF THE INVENTION

The present invention relates to a clear binder composition comprising a plasticiser, a structurant and one or more ethylene and alkyl acrylate copolymers having a melt flow index greater than 2.5 g/10 min as measured according to the method of ISO1133-1 (2011) and a melting temperature greater than or equal to 85° C. as measured according to the method of ISO 11357-3 (2018).

The present invention also relates to road and development products comprising solid particles and such a composition.

Finally, the present invention relates to the use of an ethylene and alkyl acrylate copolymer having a melt flow index greater than 2.5 g/10 min as measured according to the method of ISO1133-1 (2011) and a melting temperature greater than or equal to 85° C. as measured according to the method of ISO 11357-3 (2018) to decrease the temperature of production and/or temperature of implementation, of hot mixes, warm mixes and poured asphalts.

Other aspects of the invention are as described below in the claims.

### DETAILED DESCRIPTION OF THE INVENTION

The inventors have developed a binder composition responding to the expressed needs. Surprisingly, it has been shown that the use of an ethylene and alkyl acrylate copolymer having a melt flow index greater than 2.5 g/10 min and a melting temperature greater than or equal to 85° C. in a clear binder composition, makes it possible to obtain a clear binder having improved physico-mechanical properties, in particular from the point of view of the dynamic viscosity between 100 and 200° C. and the resistance to permanent deformation. Such compositions have a workability suitable for an application at lower temperature while ensuring good resistance of the surfacing produced from such compositions to permanent deformation over its service temperature range.

The clear binder composition developed by the inventors comprises:
(a) a plasticiser,
(b) a structurant,
(c) one or more ethylene and alkyl acrylate copolymers having a melt flow index greater than 2.5 g/10 min and a melting temperature greater than or equal to 85° C.

The expression “clear binder composition” designates a binder composition which is generally colourless or clear (e.g. white or beige). Thus, the composition is suitable for preparing clear surfacing or colourable surfacing.

The binder composition can further comprise additives commonly employed in road engineering, in particular colouring agents.

The binder composition typically contains no asphaltene. More generally, the binder composition typically contains no bitumen.

The clear binder composition generally comprises, by weight relative to the total weight of the composition:
(a) from 25 to 85% by weight, preferably from 50 to 70% by weight, of a plasticiser,
(b) from 10 to 70% by weight, preferably from 20 to 40% by weight, of a structurant,
(c) from 1 to 20% by weight, preferably from 4 to 12% by weight, of one or more ethylene and alkyl acrylate copolymers having a melt flow index greater than 2.5 g/10 min and a melting temperature greater than or equal to 85° C., and
(d) from 0 to 10% by weight, preferably from 0.3 to 3% by weight, of additives commonly used in road engineering.

The components going into the binder composition can be as described below.

### Plasticiser

The term “plasticiser” designates a chemical constituent that can fluidise and reduce the viscosity and the modulus of the binder composition. It is typically an oil. A large range of oils, referred to as lubricants, can be used in the binder composition according to the invention. Such oils are well known to a person skilled in the art.

Typically, it is a synthetic petroleum oil. An example of a synthetic petroleum oil suitable for use in the present invention is a petroleum oil resulting from a solvent extraction method of crude oil (commonly designated by the acronym RAE for “Residual Aromatic Extracts”). The oil obtained is rich in aromatic and naphthenic compounds. The extraction solvent is typically phenol, N-methylpyrrolidone and furfural. In certain embodiments, the plasticiser is an RAE oil extracted with furfural having a total content of aromatic compounds of at least 20% by weight, for example 20 to 30% by weight.

Other examples of oils that can be used as plasticiser include, without being limiting, synthetic petroleum oils resulting from the processing of crude oil distillates, synthetic oils such as poly(alpha olefins), oils of plant origin obtained from vegetables and/or plants, directly or after chemical modification, such as triglycerides, fatty acid polyol esters and oligomerised/polymerised triglycerides.

### Structurant

The term “structurant” designates any chemical constituent giving satisfactory mechanical properties and cohesiveness to the binder composition. The structurants that can be used in the preparation of clear binder compositions are well known to a person skilled in the art.

In certain embodiments, the structurant is a hydrocarbon petroleum resin, for example originating from the copolymerisation of aromatic petroleum fractions. An example of this type of resin is a hydrocarbon resin obtained by copolymerisation of an aromatic petroleum fraction rich in C9 monomers. Such a fraction results from the thermal cracking of naphtha. This aromatic petroleum fraction, rich in C9 monomer, is rich in compounds such as vinyltoluenes, dicyclopentadienes, indene, methylstyrene, styrene and methylindenes.

Other examples of resins that can be used as structurant include, without being limiting, resins from C5 aliphatic petroleum fractions, resins from C5/C9 petroleum fractions, resins of plant origin (obtained from vegetables and/or plants) such as rosin esters or polyterpenic resins or even terpene/phenol resins.

### Ethylene and Alkyl Acrylate Copolymers

The one or more ethylene and alkyl acrylate copolymers that can be used in the context of the present invention have a hot melt flow index greater than 2.5 g/10 min as measured according to the method of ISO1133-1 (2011) (190° C./2.16 kg) and a melting temperature greater than or equal to 85° C. as measured according to the method of ISO 11357-3 (2018).

Typically, the hot melt flow index (MFI) of ethylene and alkyl acrylate copolymers that can be used in the context of the present invention is greater than 2.5 and less than or equal to 700 g/10 min, preferably it varies from 6 to 320 g/10 min, even more preferably from 7 to 200 g/10 min.

The ethylene and alkyl acrylate copolymers that can be used in the context of the present invention typically comprise from 1 to 40% by weight, preferably from 10 to 35% by weight, yet more preferably from 15 to 30% by weight alkyl acrylate relative to the total weight of the copolymer.

The alkyl acrylate typically comprises alkyl groups containing 1 to 8 carbon atoms. Examples of alkyl acrylate that can be used in the context of the present invention include methyl acrylate, ethyl acrylate, butyl acrylate or the mixtures thereof.

Typically, the melting temperature of the ethylene and alkyl acrylate copolymers that can be used in the context of the present invention is less than 110° C. Preferably, the melting temperature of the ethylene and alkyl acrylate copolymers that can be used in the context of the present invention is greater than or equal to 90° C., yet more preferably greater than or equal to 95° C.

Ethylene and alkyl acrylate copolymers that can be used in the context of the present invention are prepared by a continuous radical copolymerisation process at high pressure in a tubular reactor (so-called “tubular copolymerisation method”). Tubular copolymerisation methods are well known to a person skilled in the art. For example, the ethylene and alkyl acrylate copolymers that can be used in the context of the present invention can be prepared by a method such as that described in WO 2003/051630. The ethylene and alkyl acrylate copolymers that can be used in the context of the present invention differ from ethylene and alkyl acrylate copolymers prepared by a radical copolymerisation method at high pressure in an autoclave reactor (so-called “autoclave copolymerisation method”).

### Additives

The additives can be any additive or the mixtures thereof commonly used in road engineering. Non-limiting examples of additives include waxes, adhesion enhancers, colouring agents or workability additives.

### Waxes

Waxes can further improve the dynamic viscosity when hot of binder compositions, without impacting on the rheological properties at the temperatures of use of the clear surfacings. Waxes reduce the dynamic viscosity of the binder composition when hot and provide an increase in cohesion of the composition during cooling.

Examples of waxes that can be used in the context of the present invention include, in a non-limiting manner, plant waxes (e.g.: hydrogenated castor oil), synthetic waxes resulting from the Fischer-Tropsch process, microcrystalline petroleum waxes, petroleum waxes of the slack wax type, polyethylene waxes, waxes originating from the copolymerisation of ethylene and vinyl acetate, etc.

The waxes can be added either in the binder composition or during production of the mix or of the poured asphalt in a mixture with the solid mineral particles (fillers, sand and aggregates).

### Adhesion Enhancers

Adhesion enhancers can improve the mutual affinity between the binder composition and the aggregates and ensure their durability.

Examples of enhancers that can be used in the context of the present invention include, in a non-limiting manner, nitrogenous surfactant compounds derived from fatty acids (amines, amidoamines, imidazolines), fatty acids or polymerised fatty acids, phosphate esters, organosilanes, etc.

### Colouring Agents

The colouring agents can be mineral pigments or organic colourants. The pigments are selected according to the shade, the desired colour for the surfacing. For example, metal oxides such as iron oxides, chromium oxides, cobalt oxides or titanium oxides, can be used in order to obtain the colours red, yellow, grey, green, blue or white.

The colouring agents can be added either in the binder composition or during production of the mix or the poured asphalt in a mixture with the solid mineral particles (fillers, sand and aggregates). The colouring agents can also be added to an emulsion comprising the binder composition.

### Workability Additives

Workability additives can improve the workability of compositions intended for the preparation of road and development products. The workability additives can be such as those described in EP 3 612 597 A1.

In certain embodiments, the compositions of the present invention comprise a synthetic petroleum RAE oil as plasticiser and a hydrocarbon petroleum resin resulting from the copolymerisation of aromatic petroleum fractions rich in C9 monomers as structurant.

The compositions of the present invention can be prepared by a method comprising the following steps:
(a) heating the plasticiser to a temperature ranging from 140 to 200° C., for example for 10 to 30 minutes;
(b) adding the structurant, preferably gradually, mixing and heating to a temperature ranging from 140 to 200° C., for example for 30 to 120 min;
(c) adding the ethylene and butyl acrylate copolymer, mixing and heating to a temperature ranging from 140 to 200° C., for example for 60 to 120 min;
(d) adding optional additives, mixing and heating to a temperature ranging from 140 to 200° C., for example for 5 to 20 min.

The present invention also relates to such a method.

The method steps can be carried out in the order presented or the order of the steps may be different.

The compositions of the present invention can be used in substitution with binders made from bitumen in order to prepare a wide variety of road and development products. In the following, through a misuse of language, the road and development products obtained, may be collectively designated as “bituminous products” or individually by the usual names making reference to the presence of bitumen. It is clear that in such “bituminous products”, the bitumen traditionally employed is replaced by a composition according to the present invention. Such bituminous products are then clear or can be coloured.

The compositions of the present invention can be used for preparing mixes (hot mixes, warm mixes) and poured asphalts. The low dynamic viscosity of the binder compositions of the present invention enables these products to be prepared and applied at temperatures less than those used in conventional methods for preparation and application. In particular, it has been shown that the use of an ethylene and alkyl acrylate copolymer such as previously described, makes it possible to lower the temperature of production and/or temperature of use, of hot mixes, warm mixes and poured asphalts. The present invention also relates to such a use.

The compositions of the present invention can also be used for preparing binder emulsions that can be used for preparing surface coatings, cold-poured bituminous materials, bituminous emulsion concretes and emulsion gravel. The low viscosity of the binder compositions of the present invention can facilitate emulsification, more particularly by enabling better shearing and/or a reduced heating temperature.

The present invention also relates to road and development products prepared using the compositions of the present invention. Such road and development products (bituminous products) are well known in road engineering and can be prepared by conventional techniques. For example, certain road and development products previously cited can be prepared according to methods such as those described in WO 2011/151387, EP 0 384 094, EP 0 524 031, EP 0 781 887, EP 0 552 574, FR 2 732 239 or even EP 1 668 184. The road and development products typically meet standards EN 13108-6 (December 2006), EN 12970 (December 2000), EN 13108-1 (February 2007), EN 13108-2 (December 2006), EN 13108-3 (December 2006), EN 13108-4 (December 2006), EN 13969 (September 2005), EN 13108-5 (December 2006), EN 13108-7 (December 2006) and EN 13108-9 (October 2016).

In the description given below for road and development products (or bituminous products), it is understood the term “binder”, when this is used, designates the binder composition of the present invention.

The term “road and development products” as used here or “bituminous product” as used here through a misuse of language, designates a product comprising a binder composition according to the present invention and solid particles, in particular solid mineral particles.

The term “solid particles”, designates all solid particles that can be used to produce road and development products according to the invention, in particular for the road construction and urban development using clear surfacings. Examples of solid particles include solid mineral particles such as natural mineral aggregates (gravel, sand, fines), for example originating from a quarry or gravel pit, recycling products from clear surfacings such as clear mix aggregates, for example resulting from the recycling of materials recovered during the repair of clear surfacings or surplus from clear mix plants, manufacturing scrap, aggregates coming from the recycling of road materials including concretes, slag in particular cinders, shale in particular bauxite or corundum, rubber crumbs, for example coming from the recycling of tyres, artificial aggregates of any origin and the aggregates coming, for example, from clinker from household waste incineration, and the mixtures thereof in any proportions.

The solid particles, in particular solid mineral particles, for example natural mineral aggregates, typically comprise elements less than 0.063 mm (filler or fines), sand for which the elements are between 0.063 mm and 2 mm and gravels or aggregates, for which the elements have dimensions between 2 mm and 6 mm and greater than 6 mm.

The size of the solid particles, in particular solid mineral particles, for example mineral aggregates, is measured by the tests described in standard NF EN 933-2 (July 2020).

The “solid mineral particles” are also designated by the terms “0/D mineral fraction”. This 0/D mineral fraction can be separated into two particle size distributions: the 0/d mineral fraction and the d/D mineral fraction. The finest elements (the 0/d mineral fraction) are those included in the range between 0 and a maximum diameter that can be fixed between 2 and 6 mm (from 0/2 to 0/6), advantageously between 2 and 4 mm. The other elements (minimum diameter greater than 2, 3, 4, 5 or 6 mm; and approximately up to 31.5 mm) constitute the d/D mineral fraction.

### Hot or Warm Mixes

Hot mixes are typically obtained by hot mixing of solid particles as described above (typically a mixture of fines, sand and aggregates having the specific characteristics described above) and a binder composition as described above, typically in a mix plant. The mixture is then spread and compacted.

The hot mixes prepared by means of a binder composition according to the present invention can be produced at a production temperature less than 170° C., preferably less than 160° C., yet more preferably at a temperature ranging from 140 to 155° C. (mixing and coating temperature).

The mixture can then be spread at a temperature of use less than 140-145° C., preferably less than 130° C. (e.g. for example approximately 100° C., 110° C. or 120° C.). Advantageously, the working time can be extended without negatively impacting the compactibility and workability of the product.

Warm mixes are mixes used at temperatures approximately 30 to 50° C. less than the temperatures used for hot hydrocarbon mixes.

The hot or warm mixes of the invention can be produced in any mix plant.

The hot or warm mixes generally comprise from 4 to 10% by weight of the binder composition, advantageously from 4.5 to 6.5% by weight relative to the total weight of the formulated product (in other words relative to the total weight of the mixture comprising the binder composition and the solid particles).

The hot or warm hydrocarbon mixes are typically used to produce layers and/or surfacings for road construction and/or civil engineering. They are typically used to produce running surface layers. The hot or warm hydrocarbon mixes can most particularly be used to produce running surface layers of thin bituminous concrete (TBC), semi-granular bituminous concrete (SGBC), very thin bituminous concrete (VTBC), ultra-thin bituminous concrete (UTBC), flexible bituminous concrete (FBC), draining bituminous concretes (DrBC) or high-modulus bituminous concretes (HMBC).

Hot or warm hydrocarbon mixes can be used for producing storable mixes.

### Poured Asphalts

Poured asphalts are products obtained by hot pouring a mixture comprising a binder composition, fines, sand, gravel and optionally natural asphalt powder. In poured asphalts, the interstitial spaces which may be present in the mixes are filled by sand, fines and the binder. Poured asphalts can be particularly useful for preparing surfacings of carriageways, pavements or other urban developments or even for preparing sealing layers for structures and buildings.

Poured asphalts prepared by means of a binder composition according to the present invention can be produced at a production temperature less than 200° C., preferably less than 180° C., yet more preferably at a temperature less than 160° C. (mixing and coating temperature). The mixture can be poured at a temperature of use less than 180° C., for example ranging from 120° C. to 180° C.

Poured asphalts generally comprise from 5 to 12% by weight of the binder composition, advantageously from 7 to 9% by weight relative to the total weight of the formulated product (in other words relative to the total weight of the mixture comprising the binder composition and the solid particles).

### Binder Emulsions and Bituminous Products Prepared Using Such Emulsions

Binder emulsions are commonly used for various road applications, where they can be spread in the presence of aggregates in order to produce wear surface coatings.

Binder emulsions can also be mixed with aggregates in order to obtain cold mixes, either just before laying (Cold-poured bituminous materials and recycling in place), or in mixing centres (storable mixes, emulsion gravel, bituminous emulsion concretes).

Binder emulsions are obtained by dispersing binder droplets in an aqueous phase. The binder droplets are stabilised in the continuous phase by surfactant compounds which can be anionic, non-ionic, amphoteric or cationic. The binder emulsions used in the road industry are mostly cationic in nature. These emulsions are defined and characterised according to various standards and specifications. European standard EN 13808:2013 defines the technical specifications for cationic bitumen emulsions used in road construction, road infrastructure maintenance, airports and other surfacings. This European standard applies for bitumen emulsions, fluxed bitumen emulsions, bitumen emulsions modified with polymers and fluxed bitumen emulsions modified with polymers, which also include bitumen emulsions modified with latex.

The binder emulsions according to the present invention comprise a binder composition according to the invention, water and a surfactant, preferably a cationic surfactant. The surfactants that can be used in the preparation of binder emulsions are well known to a person skilled in the art.

### Surface Dressings

Surface dressings are surfacings as described in the guide “Enduits Superficiels d'Usure”, from the Institut des Routes, des Rues et des Infrastructures pour la Mobilité, Cerema, September 2017. Typically, a surface dressing designates a layer consisting of superimposed layers of a binder in the form of an emulsion and solid particles, in particular solid mineral particles. It is typically obtained by spraying a binder then spreading solid mineral particles on this binder, in one or more layers. The assembly is then compacted.

The total content of binder in a surface dressing is adjusted as a function of the structure of the coating (single or double layer, type of gravelling), the nature of the binder and the dimensions of the solid mineral particles, in particular aggregates, following for example the recommendations of the guide “Enduits Superficiels d'Usure”, from the Institut des Routes, des Rues et des Infrastructures pour la Mobilité, Cerema, September 2017.

### Bituminous Emulsion Concretes (BEC) and Emulsion Gravels (EG)

Emulsion gravels (EG) are used for base layers, connecting layers and reprofiling; bituminous emulsion concretes (BEC) are used for running surface layers.

These products, also called emulsion mixes, are mixes produced cold from a mixture of solid particles, in particular solid mineral particles including aggregates, an emulsion binder, typically a cationic emulsion, and additives. The aggregates can be used without prior drying and heating, or undergo partial hot pre-lacquering. It may sometimes be necessary to reheat the mix obtained after its production, during its use.

This technique, referred to as “cold”, has the significant environmental advantage of not producing smoke emissions.

Emulsion gravels (EG) and bituminous emulsion concretes (BEC) are as described in the guide “Enrobés à l'émulsion fabriqués en usine” (Factory-produced emulsion mixes), from the Institut des Routes, des Rues et des Infrastructures pour la Mobilité, Cerema, 2020.

The binder employed for the synthesis of bituminous emulsion concretes is in the form of an emulsion binder. The total content of residual anhydrous binder of the cold mix is typically from 3 to 7 pph (parts per hundred by weight), advantageously from 3.5 to 5.5 pph, relative to the total weight of solid particles.

In the cold mix, the content of residual binder is between 3.5% and 5.5%, advantageously from 4.5 to 5.5%, by weight relative to the total weight of the dry mineral fraction for bituminous emulsion concretes or advantageously from 3.5% to 4.5%, by weight relative to the total weight of the dry mineral fraction for an emulsion gravel.

Bituminous emulsion concretes can be used for producing storable mixes.

### Cold-Poured Bituminous Materials (CPBM)

Cold-poured bituminous materials are mixes for surface layers consisting of solid particles, such as solid mineral particles, for example aggregates, that are not dried and are coated with binder emulsion and poured in place continuously, using specific equipment.

Cold-poured bituminous materials (CPBM) are as described in the guide “Matériaux bitumineux coules à froid” (Cold-poured bituminous materials), from the Institut des Routes, des Rues et des Infrastructures pour la Mobilité, Cerema, 2017.

After its implementation and breaking of the emulsion, this cold-poured surfacing with very low thickness (generally from 6 to 13 mm thickness per layer) must achieve its final consistency (rise in cohesion) very quickly.

The binder used for the production of cold-poured bituminous materials is in the form of an emulsion binder. In this emulsion, the content of binders varies advantageously from 50 to 75% by weight of binder, relative to the total weight of the emulsion, more advantageously from 55 to 70% by weight, yet more advantageously from 60 to 65% by weight.

The total content of residual anhydrous binder of the cold-poured bituminous material is typically, from 5.5 to 9 pph (parts per hundred by weight), advantageously 6 to 8 pph, relative to the weight of solid particles.

### EXAMPLES

### 1. Methods

### 1.1 Preparation of a Binder Composition According to the Invention

A binder composition according to the invention (example 1) comprises the following constituents:
58.9% by mass of an RAE oil characterised by a content of 27% aromatic compounds, 22% naphthenic compounds and 51% paraffin compounds, in particular as plasticiser;
34.6% by mass of a hydrocarbon petroleum resin originating from C9 monomers as structurant;
6.5% by mass, relative to the total mass of oil and resin, of an ethylene and butyl acrylate copolymer having a melt flow index greater than 2.5 g/10 min and a melting temperature greater than 85° C.

The composition of example 1 is prepared according to the following method:
(i) heating the RAE oil, for example to 170° C.;
(ii) progressively adding the resin to the oil and mixing, for example for 1 to 2 hours at 170° C. with a stirring speed of 300 rpm;
(iii) adding ethylene and butyl acrylate copolymer to the oil/resin mixture and mixing, for example, for 1 to 2 hours at 170° C. with a stirring speed of 650 rpm;
(iv) if necessary, adding a liquid adhesion enhancer then mixing, for example for 15 minutes at 170° C.

### 1.2. Melt Flow Index of Ethylene and Alkyl Acrylate Copolymers

The melt flow index is measured according to the method described in standard ISO1133-1 (2011). The copolymers are evaluated at a temperature of 190° C. and under a load of 2.16 kg.

### 1.3. Determining the Needle Penetrability (NF EN 1426—January 2018)

This test method enables determination of the consistency of bitumens, bituminous binders and hydrocarbon binders. The reference needle penetration in a conditioned test sample is measured. The operating conditions which apply to the penetrability up to approximately 330×0.1 mm, must be: temperature 25° C., applied load 100 g and duration of application of the load of 5 seconds.

### 1.4. Determination of the Softening Point—Ball and Ring Method (NF EN 1427—January 2018)

This test method enables determination of the softening point of bitumens, bituminous binders and hydrocarbon binders, in the temperature range from 28° C. to 150° C. Two horizontal discs of bitumen, moulded in brass rings with shoulder, must be heated in a liquid bath with a controlled rate of temperature increase, and each supporting a steel ball. The recorded softening point must correspond to the average of the temperatures at which the two discs soften sufficiently to enable each ball, surrounded by bituminous binder, to descend from a height of (25.0±0.4) mm.

### 1.5. Determining the Dynamic Viscosity of Bituminous Binders Using a Rotating Viscometer (NF EN 13302—June 2018)

This test method enables determination of the dynamic viscosity of various modified and unmodified bituminous binders and hydrocarbon binders, by means of a rotating viscometer (coaxial viscometer).

The torque applied to a rotating movable part (for example a cylinder) in a particular receptacle, which contains the sample to be measured, accounts for the relative resistance of the moving part to rotation and provides a measurement of the dynamic viscosity of the sample. The tests are carried out at between 100 and 180° C. by applying, for each test temperature, a close shear rate between the various samples.

### 1.6. Creep-Recovery Test Under Repeated Stresses: Test MSCR (NF EN 16659—February 2016)

This test method is used to determine the existence of an elastic response of bitumens, bituminous binders and hydrocarbon binders under creep-recovery by shearing at two stress levels, at a specified temperature. The existence of this elastic response is determined by measuring the percentage recovery and the irreversible compliance of the binder. It has been demonstrated that compliance in irreversible creep is an indicator of the resistance of binders to permanent deformation under repeated stresses.

The test must be carried out at 50° C., 60° C., 70° C. or 80° C., depending on the case. Other test temperatures can be used for comparison. The preparation of the samples and the apparatus comply with EN 14770, with a parallel plate geometry of 25 mm and an adjustment of the air gap of 1 mm. The sample is subjected to a constant stress for 1 second, followed by a recovery for 9 seconds. Ten creep-recovery cycles are carried out at a creep stress of 0.100 kPa, followed by 10 further cycles at a creep stress of 3.200 kPa

### 1.7. Evaluation of the Filamentous Appearance of Binder Compositions

A hot mix is first prepared using the binder composition. For this, the mixture below is produced at a temperature of 150° C. starting with a total mass of mix of 500 g:
Lazard aggregates 2/6: 56.50% by mass;
La Nerthe Sand 0/4: 36.30% by mass;
Additional filler (Limescale filler): 1.40% by mass;
Binder composition: 5.80% by mass.

The mix is then placed in a furnace at 120° C. for 30 minutes. At the end of 30 minutes, the temperature of the mix is checked to ensure that the mixture is indeed at 120° C., then the mix is manipulated using a spatula. The operator looks to see whether filaments are observed when manipulating the mix. If a single filament is observed, the binder is evaluated as having a filamentous appearance.

### 2. Examples

In the following examples, the ethylene and alkyl acrylate copolymers listed in table 1 below have been evaluated.

TABLE 1
Ethylene and alkyl acrylate copolymers

| Copolymer | EBA1 | EBA2 | EMA3 | EMA4 |
|---|---|---|---|---|
| Reference | Lotryl ® | Lotryl ® | Lotryl ® | Lotryl ® |
| | 28BA175T¹ | 28BA175¹ | 24MA07T¹ | 24MA02T¹ |
| Preparation | Tubular | Autoclave | Tubular | Tubular |
| Alkyl acrylate | Butyl acrylate | | Methyl acrylate | |
| % by weight | 28% | 28% | 24% | 24% |
| alkyl acrylate | | | | |
| MFI (190° C./ | 175 g/10 min | 175 g/10 min | 7 g/10 min | 2 g/10 min |
| 2.16 kg) | | | | |
| Melting point | 102° C. | 75° C. | 97° C. | 95° C. |

¹supplied by SK Functional Polymer;

The copolymers EBA1 and EMA3 are ethylene and alkyl acrylate copolymers that can be used in the context of the present invention.

The copolymers EBA2 and EMA4 are ethylene and alkyl acrylate copolymers presented by way of comparison.

### 2.1. Demonstration of the Importance of the Melting Temperature of the Copolymer

The following binder compositions were produced and characterised in order to demonstrate the importance of the melting temperature of the copolymer on the performance of the binder compositions in terms of the criterion of resistance to permanent deformation (table 2).

TABLE 2
Performance of the binder compositions

| | INV1 | COMP1 |
|---|---|---|
| C9 resin (% by mass) | 34.6 | 34.6 |
| RAE oil (% by mass) | 58.9 | 58.9 |
| Polymer type | EBA1 | EBA2 |
| Melt flow index of the copolymer | 175 | 175 |
| (g/10 min) | | |
| ISO1133-1 | | |
| Melting temperature of the copolymer | 102 | 75 |
| (° C.) | | |
| ISO 11357 | | |
| Polymer content (% by mass) | 6.5 | 6.5 |
| Penetrability at 25° C. (1/10 mm) | 52 | 53 |
| NF EN 1426 | | |
| Ball-ring temperature (° C.) | 75.4 | 53.6 |
| NF EN 1427 | | |
| MSCR test - Recovery at 3.2 kPa @60° C. | 28.2 | 1.7 |
| (%) | | |
| NF EN 16659 | | |
| MSCR test - Non-recoverable creep | 1.2 | 6.4 |
| compliance (Jnr) at 3.2 kPa (60° C.) | | |
| NF EN 16659 | | |

Dynamic viscosity (mPa · s)
NF EN 13302

| | | |
|---|---|---|
| 100° C. | 2931 | 2900 |
| 120° C. | 903 | 877 |
| 140° C. | 361 | 343 |
| 160° C. | 179 | 163 |
| Binder appearance at 120° C. | Non | Non |
| | filamentous | filamentous |

The binder composition INV1 is a composition according to the invention: the copolymer used is an EBA copolymer having an MFI of 175 g/10 min and a melting temperature of 102° C.

The binder composition COMP1 is not a composition according to the invention: the melting temperature of the EBA is 75° C., thus less than 85° C.

Despite an equivalent composition of the EBA1 and EBA2 (ethylene and butyl acrylate copolymer having a content of butyl acrylate of 28% and an MFI of 175 g/10 min), EBA1 has a melting temperature clearly higher than that of EBA2. This is explained by the nature of the method for preparing these copolymers. EBA1 is prepared according to a tubular copolymerisation method, thus generating a strong heterogeneity and thus a high melting temperature, whereas EBA2 is prepared according to an autoclave copolymerisation method, generating a homogeneous copolymer with low melting temperature. The results of characterisation of the binder compositions INV1 and COMP1 show that the heterogeneity of the copolymer is of prime importance in order to obtain a high value of ring and ball temperature and a good resistance to permanent deformation at 60° C. as indicated by the high recovery value of the composition INV1 and the low irreversible compliance of the composition INV1.

### 2.2. Demonstration of the Importance of the Melt Flow Index of the Copolymer

The following binder compositions have been produced and characterised in order to demonstrate the importance of the melt flow index of the copolymer on the reduction in dynamic viscosity of the composition and thus on its ability to be applied at lower temperature without influence on the workability of the product on application (table 3).

TABLE 3
Performance of the binder compositions

| | INV2 | COMP2 |
|---|---|---|
| C9 resin (% by mass) | 34.6 | 34.6 |
| RAE oil (% by mass) | 58.9 | 58.9 |
| Polymer type | EMA3 | EMA4 |
| Melt flow index of copolymer (g/10 min) | 7 | 2 |
| ISO1133-1 | | |
| Melting temperature of copolymer (° C.) | 97 | 95 |
| ISO 11357 | | |
| Polymer content (% by mass) | 6.5 | 6.5 |
| Penetrability at 25° C. (1/10 mm) | 47 | 49 |
| NF EN 1426 | | |
| Ball-ring temperature (° C.) | 76.2 | 72 |
| NF EN 1427 | | |
| MSCR test - Recovery at 3.2 kPa @60° C. | 50.4 | 49.4 |
| (%) | | |
| NF EN 16659 | | |
| MSCR test - Non-recoverable creep | 0.8 | 0.9 |
| compliance (Jnr) at 3.2 kPa (60° C.) | | |
| NF EN 16659 | | |

Dynamic viscosity (mPa · s)
NF EN 13302

| | | |
|---|---|---|
| 100° C. | 4535 | 5575 |
| 120° C. | 1342 | 1638 |
| 140° C. | 526 | 636 |
| 160° C. | 244 | 296 |
| | Non | Non |
| Binder appearance at 120° C. | filamentous | filamentous |

The binder composition INV2 is a composition according to the invention: the copolymer used is an EMA copolymer having an MFI of 7 g/10 min and a melting temperature of 97° C. The binder composition COMP2 is not a composition according to the invention: the melt flow index of the EMA is 2 g/10 min, thus lower than 2.5 g/m2.

Despite the similar content of methyl acrylate between EMA3 and EMA4, EMA3 has a higher melt flow index than EMA4. The characterisation results of compositions INV2 and COMP2 show that a high melt flow index is essential for obtaining a lowered dynamic viscosity value. More specifically, at 100° C., binder composition INV2 has a dynamic viscosity lowered by 1000 mPa·s compared with binder composition COMP2.

The examples of binder compositions INV3 and INV1 according to the invention, make it possible to demonstrate that a preferred mode of the invention consists of selecting copolymers for which the melt flow index is substantially high (table 4).

TABLE 4
Performance of the binder compositions

| | INV3 | INV1 |
|---|---|---|
| C9 resin (% by mass) | 33.6 | 34.6 |
| RAE oil (% by mass) | 59.9 | 58.9 |
| Polymer type | EMA3 | EBA1 |
| Melt flow index of the copolymer | 7 | 175 |
| (g/10 min) | | |
| ISO1133-1 | | |
| Melting temperature of the copolymer (° C.) | 97 | 102 |
| ISO 11357 | | |
| Polymer content ( ) | 6.5 | 6.5 |
| (% by mass) | | |
| Penetrability at 25° C. (1/10 mm) | 55 | 52 |
| NF EN 1426 | | |
| Ball-ring temperature (° C.) | 76.2 | 75.4 |
| NF EN 1427 | | |
| MSCR test - Recovery at 3.2 kPa @60° C. | 38.5 | 28.2 |
| (%) | | |
| NF EN 16659 | | |
| MSCR test - Non-recoverable creep | 1.2 | 1.2 |
| compliance (Jnr) at 3.2 kPa (60° C.) | | |
| NF EN 16659 | | |

Dynamic viscosity (mPa · s)
NF EN 13302

| | | |
|---|---|---|
| 100° C. | 4020 | 2931 |
| 120° C. | 1218 | 903 |
| 140° C. | 481 | 361 |
| 160° C. | 226 | 179 |
| Binder appearance at 120° C. | Non | Non |
| | filamentous | filamentous |

More specifically, the results for binder compositions INVS and INV1 demonstrate that at the same consistency (close values of penetrability), the use of the EBA1 which has a high melt flow index (175 g/10 min for EBA1 against 7 g/10 min for EMA3) makes it possible to obtain a substantially lower dynamic viscosity at 100° C., while maintaining an equivalent irreversible compliance between the two binders.

1. A clear binder composition comprising:
(a) a plasticiser,
(b) a structurant,
(c) one or more ethylene and alkyl acrylate copolymers having a melt flow index greater than 2.5 g/10 min as measured according to the method of ISO1133-1 (2011) and a melting temperature greater than or equal to 85° C. as measured according to the method of ISO 11357-3 (2018).

2. The binder composition according to claim 1, wherein the structurant is a hydrocarbon petroleum resin or a resin of plant origin.

3. The binder composition according to claim 1, wherein the plasticiser is a synthetic petroleum oil or an oil of plant origin.

4. The binder composition according to claim 1, wherein the ethylene and alkyl acrylate copolymer comprises from 1 to 40% by weight of alkyl acrylate relative to the total weight of the copolymer.

5. The binder composition according to claim 1, wherein the alkyl acrylate of ethylene and alkyl acrylate copolymers is methyl acrylate, ethyl acrylate, butyl acrylate or the mixtures thereof.

6. The binder composition according to claim 1, further comprising one or more additives commonly used in road engineering.

7. The binder composition according to claim 6, wherein the additive comprises at least one colouring agent.

8. A road and development product comprising solid particles and a binder composition according to claim 1.

9. The road and development product according to claim 8 chosen from hot mixes, warm mixes, poured asphalts, surface coatings, cold-poured bituminous materials, bituminous emulsion concretes and emulsion gravels.

10. (canceled)

11. The binder composition according to claim 1, wherein the structurant is a hydrocarbon petroleum resin resulting from the copolymerisation of aromatic petroleum fractions rich in C9 monomers.

12. The binder composition according to claim 1, wherein the plasticiser is a petroleum oil resulting from a solvent extraction process (RAE).

13. A method for decreasing the temperature of production, the temperature of implementation, or both, of hot mixes, warm mixes and poured asphalts, which comprises:
a) mixing solid particles with the binder composition of claim 1 to obtain a mixture,
b) spreading the mixture of step a)
c) optionally compacting the mixture spread on step b).
